(19) United States
(12) Patent Application Publication
(10) Pub. No.: US 2017/0357585 A1
(43) Pub. Date: Dec. 14, 2017

(54) SETTING CACHE ENTRY AGE BASED ON HINTS FROM ANOTHER CACHE LEVEL

(71) Applicant: Advanced Micro Devices, Inc., Sunnyvale, CA (US)

(72) Inventors: Paul James Moyer, Fort Collins, CO (US); William Louie Walker, For Collins, CO (US); Sriram Srinivasan, Fort Collins, CO (US)

(21) Appl. No.: 15/180,828

(22) Filed: Jun. 13, 2016

(51) Int. Cl. G06F 12/0811; G06F 12/0842; G06F 12/0862; G06F 12/084; G06F 12/12

(52) U.S. Cl. CPC G06F 12/0811; G06F 12/084; G06F 12/12; G06F 12/0862; G06F 12/0842; G06F 2212/602; G06F 2212/6042; G06F 2212/1024

(57) ABSTRACT

A processor replaces data at a first cache based on hints from a second cache, wherein the hints indicate information about the data that is not available to the first cache directly. When data at an entry is transferred from the first cache to the second cache, the first cache can provide an age hint to the second cache to indicate that the data should be assigned a higher or lower initial age relative to a nominal initial age. The second cache assigns the entry for the data an initial age based on the age hint and, when replacing data, selects data for replacement based on the age of each entry.

### BACKGROUND

### Field of the Disclosure

The present disclosure relates generally to processing systems and more particularly to cache management at a processing system.

### Description of the Related Art

To facilitate execution of operations, a processor can employ one or more processor cores to execute instructions and a memory subsystem to manage the storage of data to be accessed by the executing instructions. To improve memory access efficiency, the memory subsystem can be organized as a memory hierarchy, with main memory at a highest level of the memory hierarchy to store all data that can be accessed by the executing instructions and, at lower levels of the memory hierarchy, one or more caches to store subsets of data stored in main memory. The criteria for the subset of data cached at each level of the memory hierarchy can vary depending on the processor design, but typically includes data that has recently been accessed by at least one processor core and prefetched data that is predicted to be accessed by a processor core in the near future. In order to move new data into the one or more caches, the processor typically must select previously stored data for eviction based on a specified replacement scheme. For example, some processors employ a least-recently-used (LRU) replacement scheme in which the processor evicts the cache entry that stores data that has not been accessed by the processor core for the greatest amount of time. However, in many scenarios the LRU replacement scheme does not correspond with the memory access patterns of instructions executing at the processor cores, resulting in unnecessarily low memory access efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor that employs hints from one cache to implement a replacement policy at a different cache in accordance with some embodiments.

FIG. 2 is a block diagram of a cache of the processor of FIG. 1 that employs a hint from a different cache to set an age of a cache entry in accordance with some embodiments.

FIG. 3 is a block diagram of the cache of FIG. 1 for setting different ages for different cache entries based on hints from the different cache in accordance with some embodiments.

FIG. 4 is a block diagram of a method of a cache implementing a replacement policy based on hints received from a different cache in accordance with some embodiments.

### DETAILED DESCRIPTION

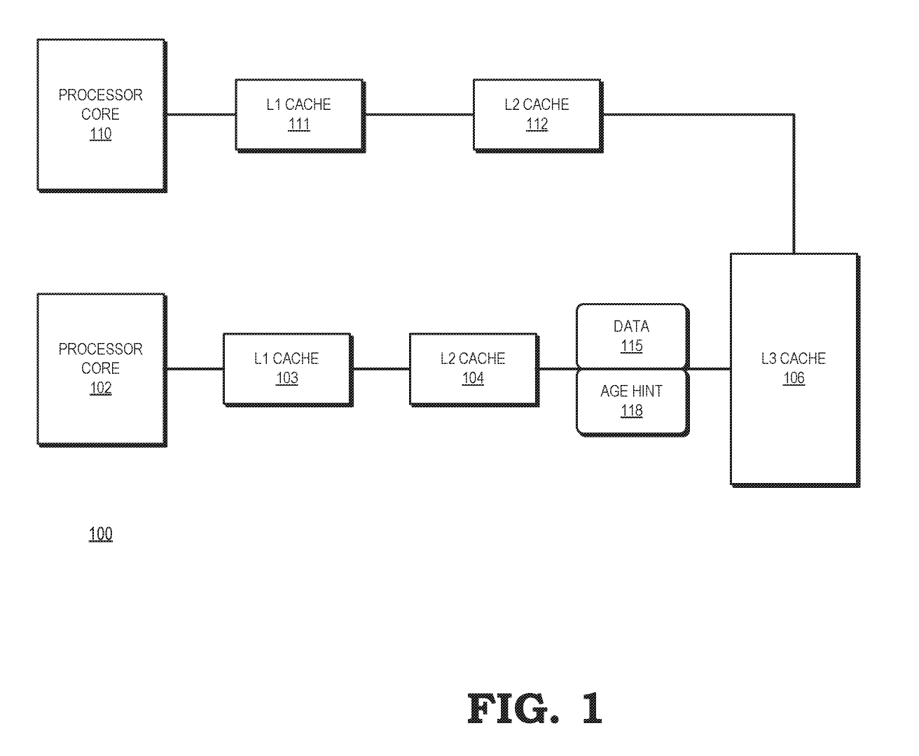

FIGS. 1-4 illustrate techniques for replacing data at one cache based on hints from a different cache, wherein the hints indicate information about the data that is not available to the cache directly. To illustrate, a cache at a higher level of a memory hierarchy can have access to information about a cache entry that is not directly available to a lower-level cache. When the data at the cache entry is transferred from the higher-level cache to the lower-level cache, the higher-level cache can provide an age hint to the lower-level cache to indicate, based on the information available to the higher-level cache, that the data should be assigned a higher or lower initial age relative to a nominal initial age. The lower-level cache assigns the entry for the data an initial age based on the age hint and, when replacing data, selects data for replacement based on the age of each entry. The age hint from the higher-level cache allows the lower-level cache to incorporate the information available to the higher-level cache in the replacement policy of the lower-level cache, thereby improving memory access efficiency.

To illustrate via an example, a processor may include a level 3 (L3) cache that is accessible to multiple processor cores of the processor, and a level 2 (L2) cache that is accessible to only one of the processor cores. Because it is shared by multiple processor cores, the L3 cache has access to status information indicating whether data at an entry is shared between different processor cores. This shared status information is unavailable to the L2 cache 104, as it is used by only one processor core. However, the shared status of the data can impact how the replacement of data at the L2 cache affects memory access efficiency. For example, for some memory access patterns it may be more efficient to select for eviction data that is shared among multiple processor cores over data that is not shared among multiple processor cores. Accordingly, by providing an age hint to the L2 cache, wherein the age hint is based at least in part of the shared status of data being transferred, the L3 cache can effectively expand the information considered by the L2 cache in its replacement policy, thereby improving memory access efficiency.

FIG. 1 illustrates a block diagram of a processor 100 that employs hints from one cache to implement a replacement policy at a different cache in accordance with some embodiments. The processor 100 is generally configured to execute sets of instructions in order to carry out tasks on behalf of an electronic device. Accordingly, the processor 100 can be used in any of a variety of electronic devices, such as a desktop or laptop computer, server, smartphone, tablet, game console, and the like.

To facilitate execution of instructions, the processor 100 includes a plurality of processor cores, including processor cores 102 and 110. Each of the processor cores includes an instruction pipeline having, for example, a fetch stage to fetch instructions, a decode stage to decode each fetched instruction into one or more operations, execution stages to execute the operations, and a retire stage to retire instructions whose operations have completed execution. To support execution of instructions at the processor cores, the processor 100 includes a memory hierarchy including multiple caches, wherein each cache includes one or more memory modules to store data on behalf of at least one of the processor cores. For example, in the illustrated embodiment of FIG. 1, the memory hierarchy of the processor 100 includes level 1 (L1) caches 103 and 111, L2 caches 104 and 112, and an L3 cache 106. In some embodiments, the memory hierarchy may also include a set of memory devices (not shown) collectively referred to as “main memory” and generally configured to store all data that can be accessed by instructions executing at one of the processor cores of the processor 100. Main memory may be located external to the processor 100 (e.g., in a separate integrated circuit package), may be located on the same die with the processor cores of the processor 100, may be located on a different die that is incorporated into a common integrated circuit package, such as in a stacked die arrangement, and the like, or a combination thereof.

The memory hierarchy of the processor 100 is organized in a hierarchical fashion with main memory being at the highest level of the hierarchy and each cache located at a specified lower level of the hierarchy, with each lower level of the hierarchy being referred to as “closer” to a corresponding processor core, as described further herein. Thus, with respect to the processor core 102, main memory is at the highest level of the memory hierarchy, the L3 cache 106 is at the next lower level, the L2 cache 104 at the next lower level relative to the L3 cache 106, and the L1 cache 103 at the lowest level of the memory hierarchy, and therefore closest to the processor core 102. Similarly, with respect to the processor core 110, main memory is at the highest level of the memory hierarchy, the L3 cache 106 is at the next lower level, the L2 cache 112 at the next lower level relative to the L3 cache 106, and the L1 cache 111 at the lowest level of the memory hierarchy, and therefore closest to the processor core 110.

In addition, each cache of the processor 100 is configured as either a dedicated cache, wherein it stores data on behalf of only the processor core to which it is dedicated, or is configured as a shared cache, wherein the cache stores data on behalf of more than one processor core. Thus, in the example of FIG. 1, the L1 cache 103 and L2 cache 104 are dedicated caches for the processor core 102, and therefore only the processor core 102 can access the L1 cache 103 and the L2 cache 104. Similarly, the L1 cache 111 and L2 cache 112 are dedicated caches for the processor core 110. The L3 cache 106 is configured as a shared cache that can be accessed by both the processor core 102 and the processor core 110. In some embodiments, the processor core 110 is connected to its own dedicated L1 cache (not shown) and L2 cache (not shown) in similar fashion to the L1 cache 103 and L2 cache 104 and their respective connections to the processor core 102.

To interact with the memory hierarchy, a processor core generates a memory access operation based on an executing instruction. Examples of memory access operations include write operations to write data to a memory location and read operations to transfer data from a memory location to the processor core. Each memory access operation includes a memory address indicating the memory location targeted by the request. The different levels of the memory hierarchy interact to satisfy each memory access request. To illustrate, in response to a memory access request from the processor core 102, the L1 cache 103 identifies whether it has an entry that stores data associated with the memory address targeted by the memory access request. If so, a cache hit occurs and the L1 cache 103 satisfies the memory access by writing data to the entry (in the case of a write operation) or providing the data from the entry to the processor core 102 (in the case of a read operation).

If the L1 cache 103 does not have an entry that stores the data associated with the memory address targeted by the memory access request, a cache miss occurs. In response to a cache miss at the L1 cache 103, the memory access request traverses the memory hierarchy until it results in a cache hit in a higher-level cache (i.e., the data targeted by the memory access request is located in the higher-level cache), or until it reaches main memory. In response to the memory access request resulting in a hit at a higher-level cache, the memory hierarchy transfers the data to each lower-level cache in the memory hierarchy, including the L1 cache 103, and then satisfies the memory access request at the L1 cache 103 as described above. Thus, for example, if the memory access request results in a hit at the L3 cache 106, the memory hierarchy copies the targeted entry from the L3 cache 106 to an entry of the L2 cache 104, and further to an entry of the L1 cache 103, where the memory access request is satisfied. Similarly, in response to the memory access request reaching main memory, the memory hierarchy copies the data from the memory location targeted by the memory access requests to each of the L3 cache 106, the L2 cache 104, and the L1 cache 103.

As described above, data is sometimes moved to from one level of the memory hierarchy to another. However, with respect to the cache levels of the memory hierarchy, each cache has limited space to store data relative to the number of memory locations that can be targeted by a memory access request. For example, in some embodiments, each cache is a set-associative cache wherein the entries of the cache are divided into sets, with each set assigned to a different subset of memory addresses that can be targeted by a memory access request. In response to receiving data from another cache or main memory, the cache identifies the memory address corresponding to the data, and further identifies whether it has an entry available to store the data in the set assigned to the memory address. If so, it stores the data at the available entry. If not, it selects an entry for replacement, evicts the selected entry by providing it to the next-higher level of the memory hierarchy, and stores the data at the selected entry.

To select an entry for replacement, each cache implements a replacement policy that governs the selection criteria. In some embodiments, the replacement policy for the L2 cache 104 is based on an age value for each entry. In particular, the L2 cache 104 assigns each entry an age value when it stores data at the entry. Further, the L2 cache 104 adjusts the age value for each entry in response to specified criteria, such as data stored at an entry being accessed. For example, in response to an entry at the L2 cache 104 being accessed by a memory access request, the age value for that entry can be decreased while the age values for all other entries are increased. To select an entry of a set for replacement, the L2 cache 104 compares the age values for the entries in the set and selects the entry having the highest age value.

In some embodiments, the L2 cache 104 sets the initial age value for an entry based on a variety of information that is available to the L2 cache 104, such as whether the data stored at the entry is instruction data (e.g., an instruction to be executed at a processor core) or operand data (e.g., data to be employed as an operand for an executing instruction), whether the data at the entry is stored in the L1 cache 103 and therefore likely to be requested in the near future, the validity of other entries of the cache in the cache set, and whether the data at the entry was stored at the L2 cache 104 in response to a prefetch request. In addition, when it provides data (e.g., data 115) to the L2 cache 104, the L3 cache 106 can provide an age hint (e.g. age hint 118) indicating information about the data that is not available to the L2 cache 104. For example, in some embodiments the L3 cache 106 can store some data that is shared—that is, can be accessed by both the processor core 110 and the processor core 102, and can store other data that is unshared and therefore can only be accessed by the processor core 102. When providing data to the L2 cache 104, the L3 cache 106 can indicate via the age hint 118 whether the data is shared data or unshared. As another example, in some embodiments an instruction executing at the processor core 110 can indicate that data at the L3 cache is “transient” data, thereby indicating a level of expectation that the data is to be repeatedly accessed by either of the processor cores 102 and 110. For example, an indication that the data is transient data can indicate that the data is not expected to be repeatedly accessed at the L2 cache 104, and therefore should be given a relatively high initial age value. Because this information is generated by an instruction at the processor core 110, it is not available to the L2 cache 104 directly. However, the L3 cache 106 can indicate via the age hint 118 whether data being provided to the L2 cache 104 is transient data. Thus, the age hint 118 gives information to the L2 cache 104 that is not available to it directly via its own stored information.

In response to receiving the data 115, the L2 cache 104 stores the data 115 at an entry and sets the initial age for the entry based at least in part on the age hint 118. In some embodiments, the L2 cache 104 sets the initial age for the entry based on a combination of the age hint 118 and the L2 data characteristics available to the L2 cache 104. For example, in some embodiments the L2 cache 104 includes an initial age table having a plurality of entries, with each entry including a different combination of L2 data characteristics and age hint values, and further including an initial age value for the combination. In response to receiving the data 115, the L2 cache 104 identifies the L2 data characteristics for the data 115, and then looks up the entry of the table corresponding to the combination of the L2 data characteristics and the age hint 118. The L2 cache 104 then assigns the initial age at the entry to the entry where the data 115 is stored.

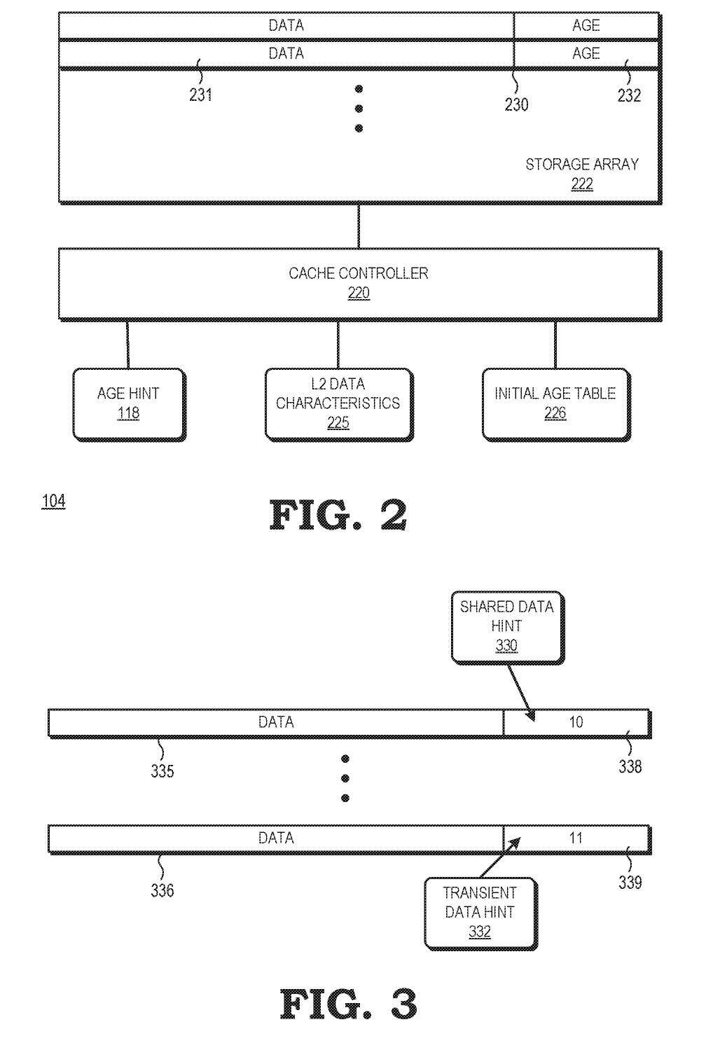

FIG. 2 illustrates a block diagram of the L2 cache 104 of FIG. 1 in accordance with some embodiments. In the depicted example, the L2 cache 104 includes a cache controller 220 and a storage array 222. The storage array 222 includes a plurality of memory cells arranged to store data on behalf of the L2 cache 104. In particular, the storage array 222 is configured to include a plurality of entries (e.g., entry 230), whereby each entry includes a data field (e.g., data field 231 of entry 230) to store data for the entry. In addition each entry includes an age field (e.g., age field 232 of entry 230) to store the age value for the entry.

The cache controller 220 is configured to control operations of the L2 cache 104, including implementation of the replacement policy at the storage array 222. Accordingly, the cache controller 220 is configured to establish an initial age value for each entry and to store the initial age value at the age field for the entry. In addition, the cache controller 220 is configured to adjust the age value for each entry based on specified criteria. For example the cache controller 220 can decrease the age value for an entry in response to the entry causing a cache hit at the L2 cache 104, and can increase the age value for the entry in response to a different entry causing a cache hit.

To establish the initial age value for an entry, the cache controller 220 employs an initial age table 226. In some embodiments, the initial age table 226 includes a plurality of entries, with each entry including a different combination of L2 data characteristics and age hint values. Each entry also includes an initial age value corresponding to the combination of L2 data characteristics and age hint. In response to the L2 cache 104 receiving the data 115, the cache controller 220 identifies L2 data characteristics 225 for the data 115. The cache controller 220 then looks up the entry of the initial age table 226 corresponding to the combination of the L2 data characteristics and the age hint 118. The cache controller then stores the identified initial age table at the age field of the entry of the storage array 222 where the data 115 is stored.

FIG. 3 depicts a block diagram illustrating an example of the L2 cache 104 assigning different initial age values to different entries based on age hints from the L3 cache 106. In particular, FIG. 3 illustrates two different entries of the L2 cache 104, designated entry 335 and entry 336 respectively. The data at each entry is provided by the L3 cache 106 along with a corresponding age hint, designated shared data hint 330 for entry 335 and transient data hint 332 for entry 336.

Shared data hint 330 indicates that the data stored at the entry 335 is shared data that can be accessed by both the processor core 102 and the processor core 110. Accordingly, in response to receiving the shared data hint 330, the L2 cache 104 stores an initial age value of “10” at an age field 338 for the entry 335. Transient data hint 332 indicates that the data stored at the entry 336 has been indicated by an instruction executing at one of the processor cores 102 and 110 as transient data that is unlikely to be repeatedly accessed. Accordingly, in response to receiving the transient data hint 332, the L2 cache 104 stores an initial age value of 11 at an age field 339 of the entry 336. Thus, in the example of FIG. 3, the L2 cache 104 stores different initial age values at different entries in response to receiving different age hints for the entries.

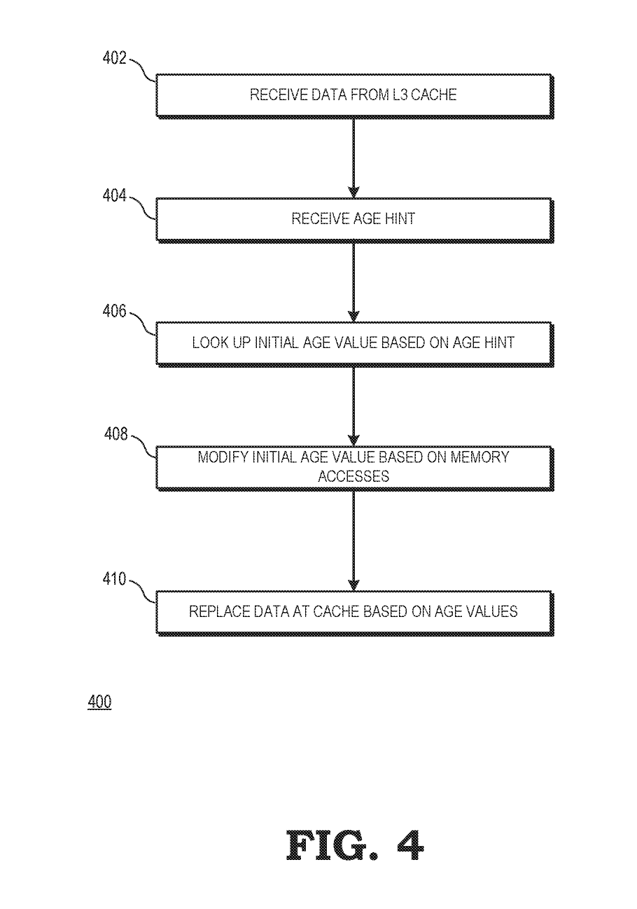

FIG. 4 illustrates a flow diagram of a method 400 of a cache implementing a replacement policy based on hints received from a different cache in accordance with some embodiments. For purposes of description, the method 400 is described with respect to an example implementation at the processor 100 of FIG. 1. At block 402 the L2 cache 104 receives data from the L3 cache 106. The L2 cache 104 selects, based on its replacement policy, an entry of the storage array 222 and stores the data at the data field of the selected entry. At block 404 the L2 cache 104 receives from the L3 cache 106 an age hint for the data received at block 402. The age hint indicates information about the data that is not directly available to the L2 cache 104, such as whether the data is shared data or whether the data has been indicated by an instruction as transient data.

At block 406, the cache controller 220 looks up an initial age value for the data at the initial age table 226 and based on the age hint received at block 404 as well as based on other characteristics of the data identified by the cache controller 220. The cache controller 220 stores the initial age value at the age field of the entry where the data is stored. At block 408 the cache controller 220 modifies the initial age value based on memory accesses to entries at the storage array 222. For example, in response to an entry being targeted by a memory access, the cache controller 220 can reduce the age value for the entry and increase the age value for other entries in the same set. At block 410, in response to receiving data to be stored at a set, and in response to identifying that there are no empty or invalid entries available in the set to store the data, the cache controller 220 selects an entry of the set for eviction based on the age values in the set. For example, the cache controller 220 can select the entry having the highest age value or, if multiple entries have the same highest age value, select among those entries at random. The cache controller 220 evicts the selected entry by providing the data at the entry to the L3 cache 106, and the stores the received data at the selected entry.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a first cache of a processor, a first hint from a second cache of the processor, the first hint indicating a first characteristic of first data stored at the second cache and wherein the first characteristic is unavailable to the first cache, the first cache and the second cache comprising different levels of a memory hierarchy of the processor;
storing the first data at a first entry of the first cache;
setting a first age value for the first entry based on the first hint; and
replacing the first entry based on a comparison of the first age value to age values for entries of the first cache other than the first entry.

2. The method of claim 1, wherein the first characteristic comprises a transient indication associated with the first data, the transient indication indicating a level of expectation that the first data will be accessed at the first cache.

3. The method of claim 2, further comprising identifying the transient indication at the second cache based on an instruction executed at the processor.

4. The method of claim 1, wherein the first characteristic comprises a shared characteristic indicating whether the first data is shared among multiple processor cores of the processor.

5. The method of claim 1, further comprising:
identifying the first age value based on the first hint and a second characteristic of the first data, the second characteristic identified at the first cache.

6. The method of claim 1, further comprising:
receiving, at the first cache of a processor, a second hint from the second cache of the processor, the second hint indicating a second characteristic of second data stored at the second cache and wherein the second characteristic is not identifiable at the first cache;
storing the second data at a second entry of the first cache;
setting a second age value for the second entry based on the second hint; and
replacing the second entry based on a comparison of the second age value to age values for entries of the first cache other than the second entry.

7. The method of claim 6, wherein the second characteristic is different from the first characteristic.

8. The method of claim 6, wherein the second characteristic is the same as the first characteristic and the second age value is different from the first age value.

9. A method, comprising:
identifying, at a first cache of a processor, a first characteristic of data stored at the first cache;
in response to receiving a request for the data from a second cache of the processor:
providing the data from the first cache to the second cache;
providing a hint as to the identified first characteristic of the data to the second cache; and
setting an age value for the data at the second cache based on the hint; and
replacing the data at the second cache based on a comparison of the age value to age values for entries of the second cache other than an entry storing the data.

10. The method of claim 9, wherein setting the age value comprises:
setting the age value for the data at the second cache based on the hint and a second characteristic of the data identified at the second cache.

11. The method of claim 9, wherein the first characteristic comprises a transient indication associated with the first data, the transient indication indicating a level of expectation that the first data will be accessed at the first cache.

12. The method of claim 9, wherein the first characteristic comprises a shared characteristic indicating whether the first data is shared among multiple processor cores of the processor.

13. A processor, comprising:
a first cache to store first data and to identify a first characteristic of the first data; and
a second cache comprising a first entry to receive and store the first data from the first cache, the first cache and the second cache comprising different levels of a memory hierarchy of the processor, the second cache to:
receive a first hint from the second cache indicating the first characteristic and wherein the first characteristic is not identifiable at the first cache;
set a first age value for the first entry based on the first hint; and
replace the first entry based on a comparison of the first age value to age values for entries of the first cache other than the first entry.

14. The processor of claim 13, wherein the first characteristic comprises a transient indication associated with the first data, the transient indication indicating a level of expectation that the first data will be accessed at the second cache.

15. The processor of claim 14, wherein the first cache is to:
identify the transient indication based on a second hint provided by an instruction executed at the processor.

16. The processor of claim 13, wherein the first characteristic comprises a shared characteristic indicating whether the first data is shared among multiple processor cores of the processor.

17. The processor of claim 13, wherein the second cache is to:
identify the first age value based on the first hint and a second characteristic of the first data, the second characteristic identified at the second cache.

18. The processor of claim 13, wherein:
the first cache is to store second data and is to identify a second characteristic of the second data;
the second cache comprises a second entry to receive and store the second data from the first cache, the second cache to:
receive a second hint from the first cache, the second hint indicating a second characteristic of the second data, wherein the second characteristic is not identifiable at the first cache;
set a second age value for the second entry based on the second hint; and
replace the second entry based on a comparison of the second age value to age values for entries of the first cache other than the second entry.

19. The processor of claim 18, wherein the second characteristic is different from the first characteristic.

20. The processor of claim 18, wherein the second characteristic is the same as the first characteristic and the second age value is different from the first age value.
